(19) United States
(12) Patent Application Publication
(10) Pub. No.: US 2010/0157857 A1
(43) Pub. Date: Jun. 24, 2010

(54) APPARATUS AND METHOD FOR SHARING OF FREQUENCY ALLOCATED FOR MOBILE SATELLITE SERVICE USING SATELLITE AND ITS COMPLEMENTARY GROUND COMPONENT

(75) Inventors: Bon Jun Ku, Daejeon (KR); Do-Seob Ahn, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/560,757

(22) Filed: Sep. 16, 2009

(30) Foreign Application Priority Data
Dec. 19, 2008 (KR) 10-2008-0130432

(51) Int. Cl. H04J 1/00; H04B 7/185

(52) U.S. Cl. 370/281; 455/12.1

(57) ABSTRACT

A disclose is a frequency sharing apparatus and method for a mobile satellite service using a satellite and a CGC of the satellite. The frequency sharing method may include measuring a signal strength of a signal received from a satellite, determining a communication mode according to the measured signal strength; and communicating with one of the satellite and a CGC of the satellite, depending on the communication mode.

### CROSS-REFERENCE TO RELATED APPLICATION

This application claims the benefit of Korean Patent Application No. 10-2008-0130432, filed on Dec. 19, 2008, in the Korean Intellectual Property Office, the disclosure of which is incorporated herein by reference.

### BACKGROUND

1. Field

The present invention relates to a frequency sharing method and apparatus for a mobile satellite service using a satellite and a complementary ground component (CGC) of the satellite, and more particularly, to a frequency sharing method and apparatus for a mobile satellite service, the frequency sharing method and apparatus being efficient in utilizing a frequency by using a CGC of a satellite that reuses a frequency band allocated for the mobile satellite service.

2. Description of the Related Art

An International Mobile Telecommunications (IMT)-advanced satellite service provides services in downtown areas where a satellite signal is weak using a complementary ground component (CGC) of the satellite, and provides services in a countryside or suburbs where a line of sight (LOS) is relatively constant and an infrastructure of a ground mobile base station is weak, by establishing a direct communication link between the satellite and a satellite mobile terminal. The IMT-advanced satellite service has a compatibility with a fourth-generation (4G) mobile communication technology, and is capable of providing service without drops by using a satellite network or a terrestrial network.

The provided services may include a personal portable mobile satellite communication service and a high quality of a bidirectional multicasting service which is one of a Beyond 3^{rd} Generation/4^{th} Generation (B3G/4G) service, a broadcasting and multicasting service by utilizing the IMT-advanced satellite wireless access standard, an integral service associated with a terrestrial network using a chip having a satellite interface reception function, and a service for narrowing a gap in a digital technology by complementing a terrestrial shadow area, such as a remote country area, a national park, and the like, and by providing an emergency disaster communication service, and the like.

FIG. 1 is a diagram illustrating a satellite network of a mobile satellite service using a satellite and a CGC of the satellite.

Referring to FIG. 1, the satellite network is classified into a satellite part and a ground part. The satellite part indicates a satellite 101, and the ground part includes a satellite gateway 103, a satellite mobile terminal 105, and a CGC 107 of the satellite. The satellite 101 is designed to have a single terrestrial beam coverage or to have a terrestrial multi-beam coverage. The satellite gateway 103 performs transmission/reception of data with the satellite 101 through a feeder link, and is connected to an existing terrestrial network over a core network 109, and is connected to a ground mobile base station 113 through a base station controller 111.

Communication and broadcasting services using a stationary satellite may obtain a larger service area than beam coverage of a satellite located at a high-altitude or at a mid-altitude since the satellite located in a high-altitude or at a mid-altitude is located in a geostationary orbit. However, the satellite located in the geostationary orbit cannot expect a sufficient line margin from communication with a subscriber when using a single huge beam for a broad area. To overcome the described difficulty, multiple beams may be applied instead of a single beam that is received by the satellite or transmitted from the satellite. Also, a capacity of the mobile satellite service may be increased by using the CGC of the satellite, in an area such as a downtown area and the like, having difficulty in receiving the satellite signal.

Frequency efficiency may differently increase depending on an application of a frequency reuse combination between the multiple beams of the satellite and the CGC. As an example, when the beam from the satellite is difficult to be delivered to the subscriber in the downtown area, the CGC of the satellite may use a corresponding frequency band, thereby increasing the capacity of the mobile satellite service.

Hereinafter, a method of using a frequency between the satellite mobile terminal 105 and the satellite 101 and a frequency between the satellite mobile terminal 105 and the CGC 107 of the satellite will be described. In this instance, from the satellite mobile terminal 105 to the satellite 101 is defined as an uplink (fᵤ) and from the satellite 101 to the satellite mobile terminal 105 is defined as a downlink (f_{d}). Also, a communication scheme between the satellite 101 and the satellite mobile terminal 105 may utilize a frequency division duplex (FDD) scheme, and a communication scheme between the CGC 107 of the satellite and the satellite mobile terminal 105 may utilize either a time division duplex (TDD) scheme or the FDD scheme.

The method of using the frequency between the satellite mobile terminal 105 and the satellite 101, and the frequency between the satellite mobile terminal 105 and the CGC 107 of the satellite may be roughly classified into the following four categories.

First, the frequency (fᵤ and f_{d}) between the satellite 101 and the satellite mobile terminal 105 and a frequency (fᵤ and P_{d}) between the CGC 107 and the satellite mobile terminal 105 are different from each other, and all use the FDD scheme.

Second, the frequency (fᵤ and f_{d}) between the satellite 101 and the satellite mobile terminal 105 and the frequency (fᵤ and f_{d}) between the CGC 107 and the satellite mobile terminal 105 are different from each other. Also, the FDD scheme is used for communication between the satellite 101 and the satellite mobile terminal 105 and the TDD scheme is used for communication between the CGC 107 and the satellite mobile terminal 105.

Third, the frequency (fᵤ and f_{d}) between the satellite 101 and the satellite mobile terminal 105 and the frequency (fᵤ and f_{d}) between the CGC 107 and the satellite mobile terminal 105 are identical to each other, and all use the FDD scheme.

Fourth, the frequency (fᵤ and f_{d}) between the satellite 101 and the satellite mobile terminal 105 and the frequency (fᵤ and f_{d}) between the CGC 107 and the satellite mobile terminal 105 are identical to each other. Also, the FDD scheme is used for communication between the satellite 101 and the satellite mobile terminal 105 and the TDD scheme using an uplink frequency between the satellite 101 and the satellite mobile terminal 105 is used for communication between the CGC 107 and the satellite mobile terminal 105.

The third and the fourth method among the four methods use a same frequency band instead of using different frequencies, thereby increasing the frequency efficiency. However, the methods have a weak point of requiring an additional device for eliminating interference, since the interference that affects a satellite receiving unit is generated in a terrestrial system. As an example, according to the third method, when two systems operate according to the FDD scheme, an interference where a downlink signal of between the CGC and the satellite mobile terminal affects another satellite mobile terminal, and also an interference where an uplink signal between the satellite mobile terminal and the CGC affects the satellite receiving unit, may occur. Also, according to the fourth method, when the CGC and the satellite mobile terminal operate according to the TDD scheme, an interference where a signal between the CGC and the satellite mobile terminal affects the satellite receiving unit may occur.

Accordingly, there may be need for a frequency sharing apparatus and method for a mobile satellite service using the satellite and the CGC of the satellite, the frequency sharing apparatus and method being capable of overcoming a weak point of an interference to the satellite receiving unit and a system complexity

### SUMMARY

An aspect of the present invention may provide a frequency sharing method and apparatus for a mobile satellite service, the frequency sharing method and apparatus being efficient in utilizing a frequency by using a complementary ground component (CGC) of a satellite that reuses a frequency band allocated for the mobile satellite service, and also being capable of minimizing an interference to the satellite receiving unit and system complexity

According to an aspect of the present invention, there may be provided a satellite mobile terminal, including a signal strength measuring unit to measure a signal strength of a signal received from a satellite, a communication mode determining unit to determine a communication mode according to the measured signal strength, and a communication unit to communicate with any one of the satellite or a CGC of the satellite, according to the communication mode.

According to an aspect of the present invention, there may be provided a communication method of a satellite mobile terminal, including measuring a signal strength of a signal received from a satellite, determining a communication mode according to the measure signal strength, and communicating with any one of the satellite and a CGC of the satellite, according to the communication mode.

Additional aspects and/or advantages will be set forth in part in the description which follows and, in part, will be apparent from the description, or may be learned by practice of the embodiments.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating a satellite network of a mobile satellite service using a satellite and a complementary ground component (CGC) of the satellite;

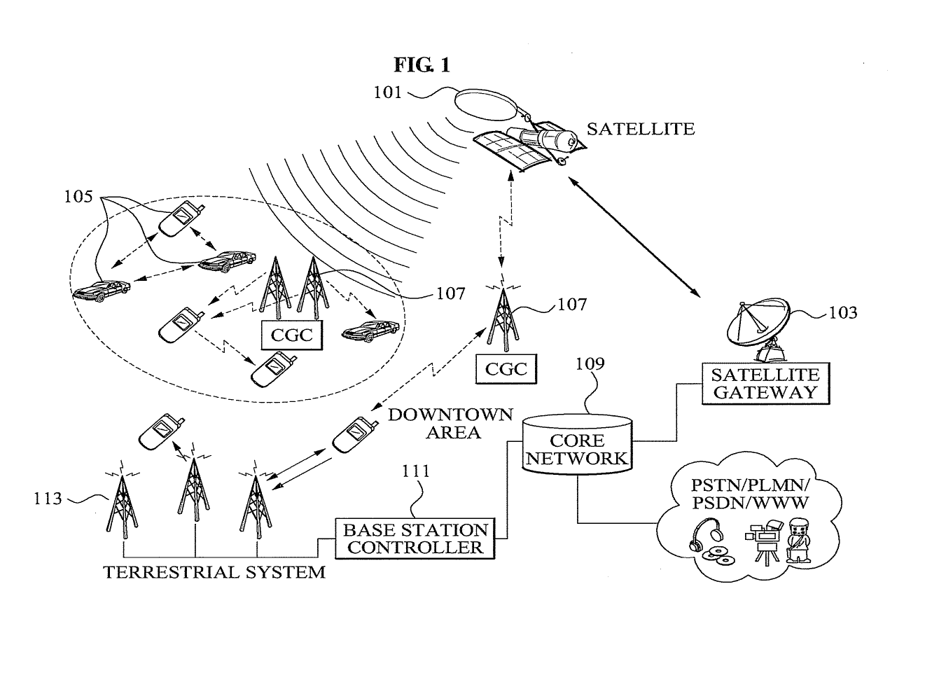

FIG. 2 is a diagram illustrating a configuration of a frequency sharing apparatus for a mobile satellite service using a satellite and a CGC of the satellite according to an example embodiment of the present invention;

FIG. 3 is a diagram illustrating a communication between a satellite mobile terminal and a satellite;

FIG. 4 is a diagram illustrating a communication between a CGC and a satellite;

FIG. 5 is a diagram illustrating a communication mode that is changed according to a variation of a strength of a satellite signal; and

FIG. 6 is a flowchart illustrating a communication method of a satellite mobile terminal of a frequency sharing apparatus for a mobile satellite service using a satellite and a CGC of the satellite according to an embodiment of the present invention.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

Hereinafter, a frequency sharing apparatus and method for a mobile satellite service using a satellite and a complementary ground component (CGC) of the satellite according to an example embodiment of the present invention will be described in detail with reference attached drawings.

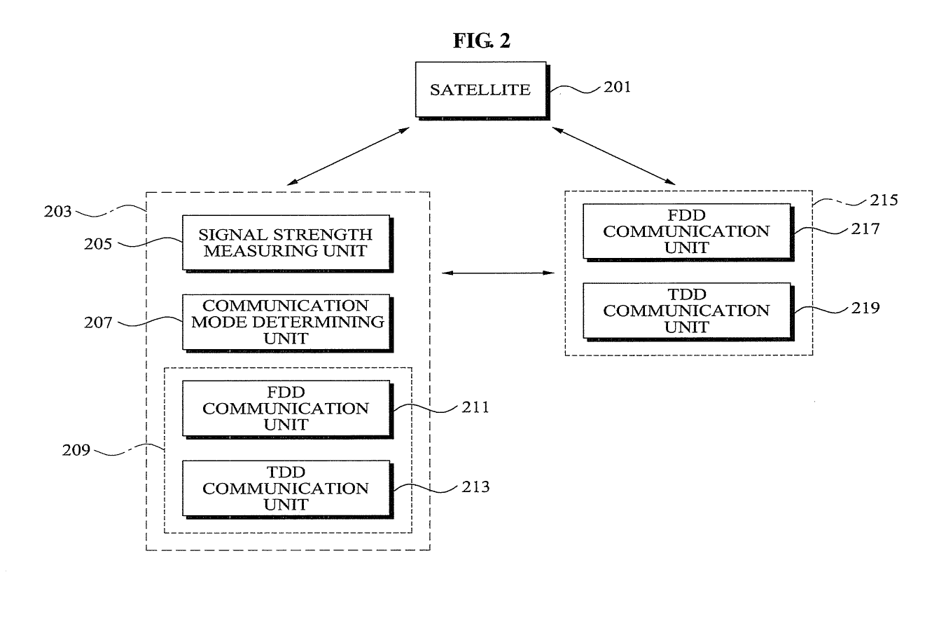

FIG. 2 is a diagram illustrating a configuration of a frequency sharing apparatus for a mobile satellite service using a satellite and a CGC of the satellite according to an example embodiment of the present invention.

Referring to FIG. 2, the frequency sharing apparatus for the mobile satellite service using the satellite and the CGC of the satellite according to the present exemplary embodiment may include a satellite 201, a satellite mobile terminal 203, and a CGC 215 of the satellite.

The satellite mobile terminal 203 may include a signal strength measuring unit 205, a communication mode determining unit 207, and a communication unit 209.

The signal strength measuring unit 205 may measure a signal strength of a signal received from the satellite 201.

The communication mode determining unit 207 may determine a communication mode as a satellite mode for communicating with the satellite when the measured signal strength is greater than or equal to a predetermined signal value, and may determine the communication mode as a ground mode for communicating with the CGC 215 of the satellite when the measured signal strength is less than the predetermined signal value.

The communication unit 209 may include a frequency division duplex (FDD) communication unit 211 to communicate with the satellite in an FDD scheme when the communication mode is the satellite mode, and a time division duplex (TDD) communication unit 213 to communicate with the CGC of the satellite in a TDD scheme when the communication mode is the ground mode.

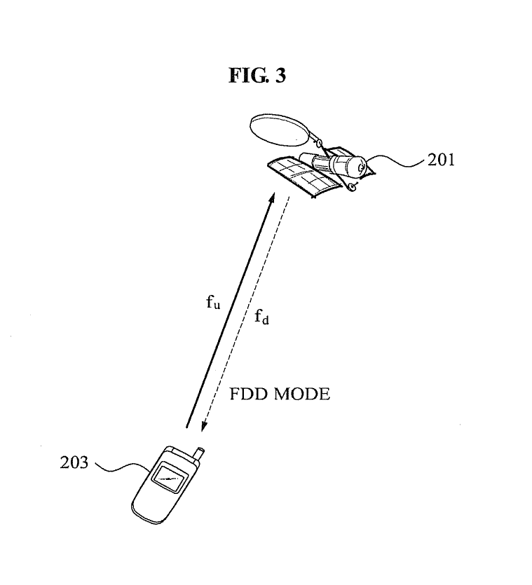

FIG. 3 is a diagram illustrating a communication between a satellite mobile terminal and a satellite. As illustrated in FIG. 3, the TDD communication unit 211 may establish a direct communication link with the satellite 201 in a countryside or suburbs where a line of sight (LOS) is constant and an infrastructure of a ground mobile base station is weak. That is, the FDD communication unit 211 may use an uplink frequency as an fᵤ, and may use a downlink frequency as an f_{d} between the communication unit 211 and the satellite 201.

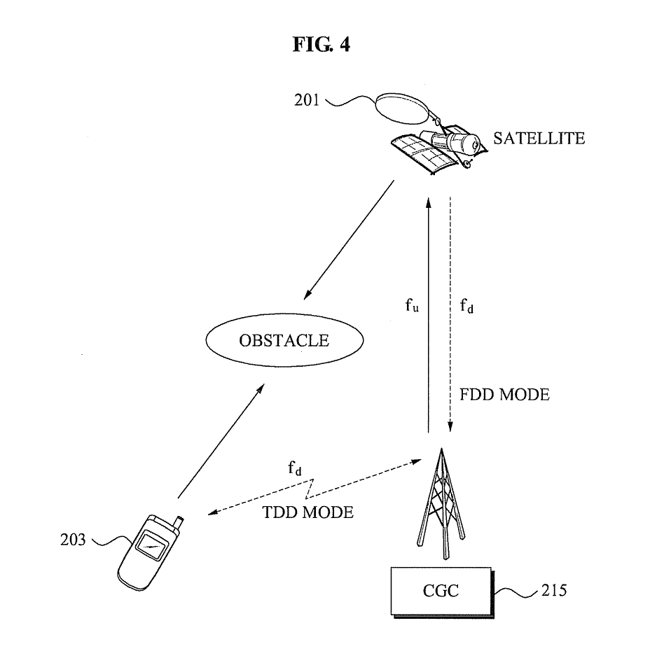

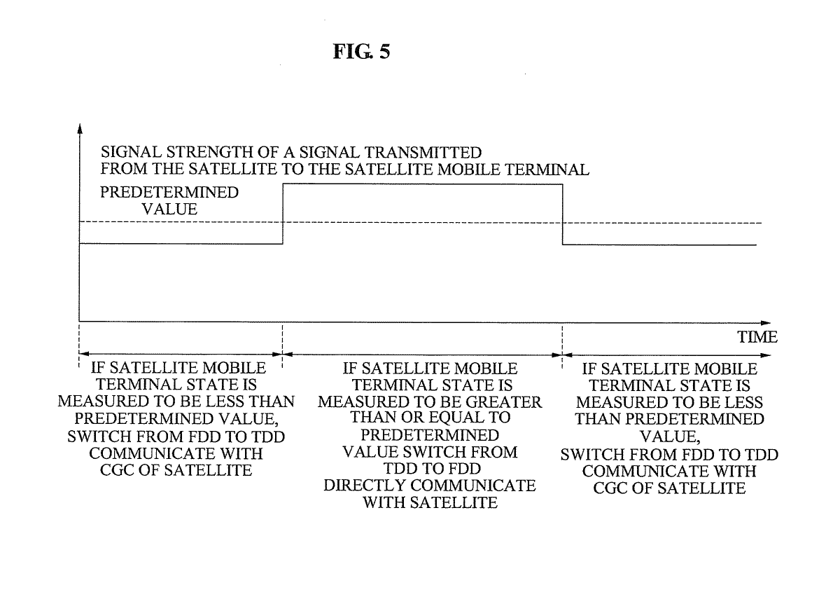

FIG. 4 is a diagram illustrating a communication between a CGC and a satellite. FIG. 5 is a diagram illustrating a communication mode that is changed according to a variation of a strength of a satellite signal. As illustrated in FIG. 4, when an obstacle exists between the satellite 201 and the satellite mobile terminal 203, the TDD communication unit 213 may communicate with the CGC 215 of the satellite in the TDD scheme using the downlink frequency f_{d} between the satellite 201 and the CGC 215 of the satellite.

That is, as illustrated in FIG. 5, according to a communication mode determined by the communication mode determining unit 207, during communication the communication unit 209 may communicate with the satellite 201 in the FDD scheme when a signal strength of a signal received from the satellite 201 is greater than or equal to a predetermined signal value and may communicate with the satellite 201 in the TDD scheme when the signal strength of the signal received from the satellite 201 is less than the predetermined signal value.

The CGC 215 of the satellite may include an FDD communication unit 217 to communicate with the satellite 201 in the FDD scheme, and a TDD communication unit 219 to communicate with the satellite mobile terminal 203 in the TDD scheme.

The TDD communication unit 219 may communicate with the satellite mobile terminal 203 in the TDD scheme using the downlink frequency f_{d}, when receiving a signal from the satellite mobile terminal 203 that communicates with the satellite 201.

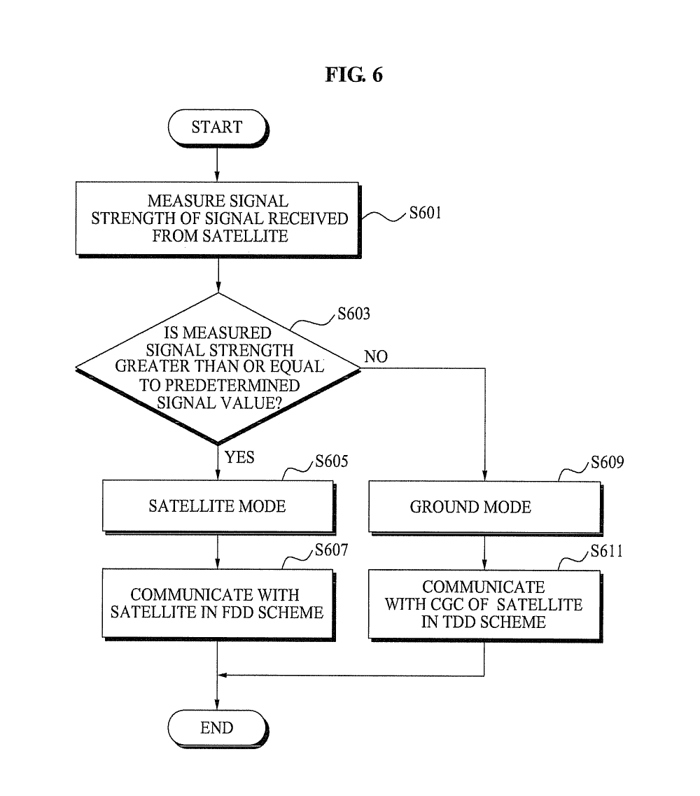

FIG. 6 is a flowchart illustrating a communication method of a satellite mobile terminal of a frequency sharing apparatus for a mobile satellite service using a satellite and a CGC of the satellite according to an embodiment of the present invention.

Referring to FIG. 6, the satellite mobile terminal measures a signal strength of a signal received from a satellite in operation S601.

Next, the satellite mobile terminal determines a communication mode according to the measured signal strength.

Particularly, the satellite mobile terminal determines the communication mode as a satellite mode for communicating with the satellite in operation S605 when the measured signal strength is greater than or equal to a predetermined signal value in operation 5603. Conversely, the satellite mobile terminal determines the communication mode as a ground mode for communicating with the CGC of the satellite in operation 5609 when the measured signal strength is less than the predetermined signal value in operation S603.

Next, the satellite mobile terminal may communicate with the satellite or with the CGC of the satellite.

Particularly, when the communication mode is the satellite mode as determined in operation 5605, the satellite mobile terminal communicates with the satellite in an FDD scheme in operation S607. That is, the satellite mobile terminal may communicate with the satellite in the FDD scheme using an fᵤ as an uplink frequency and using an f_{d} that is different from the fᵤ as an downlink.

Conversely, when the communication mode is the ground mode as determined in operation S609, the satellite mobile terminal communicates with the CGC of the satellite in the TDD scheme in operation 5611. In this instance, the satellite mobile terminal may communicate with the CGC of the satellite in the TDD scheme using the f_{d} that is a downlink frequency of the satellite.

The frequency sharing apparatus and method for the mobile satellite service using the satellite and the CGC of the satellite according to the present exemplary embodiment reuses a frequency band of a satellite downlink for a link between the CGC of the satellite and the satellite mobile terminal, and measures a signal strength of the satellite signal in the satellite mobile terminal to determine a satellite mode for communicating with the satellite or a ground mode for communicating with the CGC of the satellite, thereby providing an efficient frequency sharing method capable of reducing an interference to a satellite receiving unit.

Although a few example embodiments have been shown and described, it would be appreciated by those skilled in the art that changes may be made in these example embodiments without departing from the principles and spirit of the invention, the scope of which is defined in the claims and their equivalents.

What is claimed is:

1. A satellite mobile terminal, comprising:
a signal strength measuring unit to measure a signal strength of a signal received from a satellite;
a communication mode determining unit to determine a communication mode according to the measured signal strength; and
a communication unit to communicate with any one of the satellite or a complementary ground component (CGC) of the satellite, according to the communication mode.

2. The satellite mobile terminal of claim 1, wherein the communication mode determining unit determines the communication mode as a satellite mode for communicating with the satellite when the measured signal strength is greater than or equal to a predetermined signal value, and determines the communication mode as a ground mode for communicating with the CGC of the satellite when the measure signal strength is less than the predetermined signal value.

3. The satellite mobile terminal of claim 1, wherein the communication unit comprises:
a frequency division duplex (FDD) communication unit to communicate with the satellite in an FDD scheme when the communication mode is the satellite mode; and
a time division duplex (TDD) communication unit to communicate with the CGC of the satellite in a TDD scheme when the communication mode is the ground mode.

4. The satellite mobile terminal of claim 3, wherein the TDD communication unit communicates with the CGC of the satellite in the TDD scheme using a frequency band of a satellite downlink.

5. A CGC of a satellite, comprising:
an FDD communication unit to communicate with the satellite in a FDD scheme; and
a TDD communication unit to communicate with a satellite mobile terminal in a TDD scheme when receiving a signal from the satellite mobile terminal that communicates with the satellite.

6. The CGC of the satellite of claim 5, wherein the TDD communication unit communicates with the satellite mobile terminal in the TDD scheme using a frequency band of the satellite downlink.

7. A communication method of a satellite mobile terminal, comprising:
measuring a signal strength of a signal received from a satellite;
determining a communication mode according to the measure signal strength; and
communicating with any one of the satellite and a CGC of the satellite, according to the communication mode.

8. The method of claim 7, wherein the determining of the communication mode comprises:
determining the communication mode as a satellite mode for communicating with the satellite when the measured signal strength is greater than or equal to a predetermined signal value; and
determining the communication mode as a ground mode for communicating with the CGC of the satellite when the measured signal strength is less than the predetermined signal value.

9. The method of claim 7, wherein the communicating with any one of the satellite and the CGC of the satellite comprises:
communicating with the satellite in a FDD scheme when the communication mode is the satellite mode; and
communicating with the CGC of the satellite in a TDD scheme when the communication mode is the ground mode.

10. The method of claim 9, wherein the communicating with the CGC of the satellite communicates with the CGC of the satellite in the TDD scheme using a frequency band of a satellite downlink.
